(19) United States
(12) Patent Application Publication
(10) Pub. No.: US 2015/0310716 A1
(43) Pub. Date: Oct. 29, 2015

(54) SYSTEM AND METHOD FOR PREVENTING LOSS OF ASSET

(71) Applicant: Tracfind, Inc., Clearwater, FL (US)

(72) Inventor: Clark D. East, Clearwater, FL (US)

(21) Appl. No.: 14/796,559

(22) Filed: Jul. 10, 2015

Related U.S. Application Data
(63) Continuation-in-part of application No. 14/615,702, filed on Feb. 6, 2015.
Application No. 14/615,702 is a continuation-in-part of application No. 14/479,958, filed on Sep. 8, 2014.
(60) Provisional application No. 61/874,466, filed on Sep. 6, 2013.

(51) Int. Cl. G08B 13/24; G08B 21/02

(52) U.S. Cl. CPC G08B 13/2462; G08B 21/0261

(57) ABSTRACT

A method of preventing a loss of an asset is provided. The method includes 1) providing a device that is logged into a national database of law enforcement agencies, 2) detecting a movement of the device outside of a predefined perimeter, and 3) upon detecting the movement, immediately providing a direct link for tracking such movement to at least one law enforcement agency of the national database.

### CROSS-REFERENCE TO RELATED APPLICATION

This application is a continuation-in-part U.S. patent application Ser. No. 14/615,702, filed on Feb. 6, 2015, entitled “System and Method for Tracking Assets,” which is a continuation-in-part of U.S. patent application Ser. No. 14/479,958, filed on Sep. 8, 2014, entitled “System and Method for Tracking Assets,”, both of which claim the benefit of U.S. Patent Application Ser. No. 61/874,466 filed on Sep. 6, 2013, which are commonly assigned with this application and incorporated herein by reference.

### TECHNICAL FIELD

This invention relates, generally, to global positioning systems (“GPS”) system. More specifically, it relates to a GPS system and a method of preventing a loss of a secured item with an associated tag.

### BACKGROUND

Global positioning system tracking is a method of tracking an exact location of an object. A GPS tracking system, for example, may be placed in a vehicle, on a cell phone, or on special GPS devices, which can either be a fixed or portable unit. GPS works by providing information on exact location. It can also track the movement of a vehicle or person. For example, a GPS tracking system can be used by a company to monitor the route and progress of a delivery truck, and by parents to check on the location of their child, or even to monitor high-valued assets in transit.

GPS chips or tags are well-known in the art. GPS chipsets are utilized to track various objects or persons, including children, electronics, firearms, etc., from an electronic device. The electronic device simply fires a signal through a server to the chipset, and the chipset returns a signal containing its location.

The issue of installing GPS systems on or in firearms has been discussed previously, for example in McCarthy, Kevin E. “Feasibility of Installing Global Positioning Systems on Firearms”, OLR Research Report, State of Connecticut General Assembly, Office of Legislative Research, 2013-R-0069 (Jan. 24, 2013). The foregoing publication discusses several patent applications—such as U.S. Patent Pub. No. 2011/0309975 and EPO App. No. EP2282158—and products—such as PORTMAN SECURITY SYSTEMS Weapons Intelligent Tracking System and 3ARC Weapons Intelligent Tracking System—that attempt to resolve this issue. However, the article points out several drawbacks of the existing art, for example ineffective or incomplete tracking, insufficient battery life and the ability to thwart the system by failing to recharge the battery, and privacy concerns.

There are many further drawbacks of current GPS chips as well. One, in particular, is the one-on-one nature of conventional devices, which further contributes to a lack of security and backup mechanisms. For example, if a firearm is stolen and the owner of the firearm is unavailable to track the firearm, then the owner would not unable to retrieve the firearm, and the firearm would remain in the wrong hands, which may lead to further crimes. Another drawback is that current GPS chips generally do not utilize power efficiently. Since GPS chips run on power supplied by an on-board battery, frequent signal transmission and reception by GPS chips drain limited battery power, thereby decreasing operating time.

Accordingly, what is needed is a more effective system and method of tracking assets and persons with GPS-tracked tags that are capable of being tracked by users and authorized third parties, such as law enforcement. Also, what is needed is an efficient system and a method that allow a law enforcement agency to track a potentially lost/stolen asset immediately after the asset has moved since the first few hours of recovery is the most critical time in retrieving the asset.

However, in view of the art considered as a whole at the time the invention was made, it was not obvious to those of ordinary skill in the field of this invention how the shortcomings of the prior art could be overcome.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies, and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY

One aspect provides a method of preventing a loss of an asset. The method includes: (1) providing a device that is logged into a national database of law enforcement agencies, (2) detecting a movement of the device outside of a predefined perimeter and (3) upon detecting the movement, immediately providing a direct link for tracking such movement to at least one law enforcement agency of the national database.

Other aspect provides a system for preventing a loss of an asset. The system includes a server; and a device logged into a national database of law enforcement agencies. The device includes: (1) an accelerometer configured to detect a movement of the device outside of a predefined perimeter, (2) a transceiver circuit configured to cause, upon the detection by the accelerometer, the server to immediately provide at least one law enforcement agency of the law enforcement agencies a direct link for tracking the movement of the device and (3) a battery coupled to the accelerometer and to the transceiver circuit.

### BRIEF DESCRIPTION

Reference is now made to the following descriptions taken in conjunction with the accompanying drawings, in which:

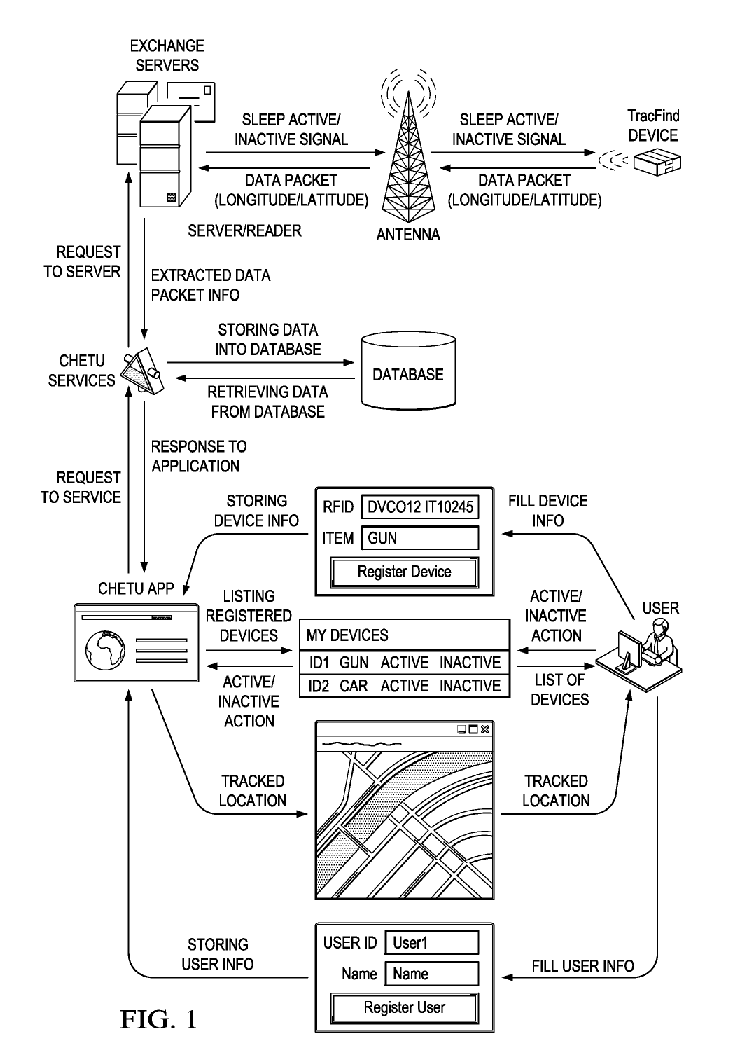

FIG. 1 depicts an architecture for a computer-based application and relationships among the entities according to an embodiment of the invention;

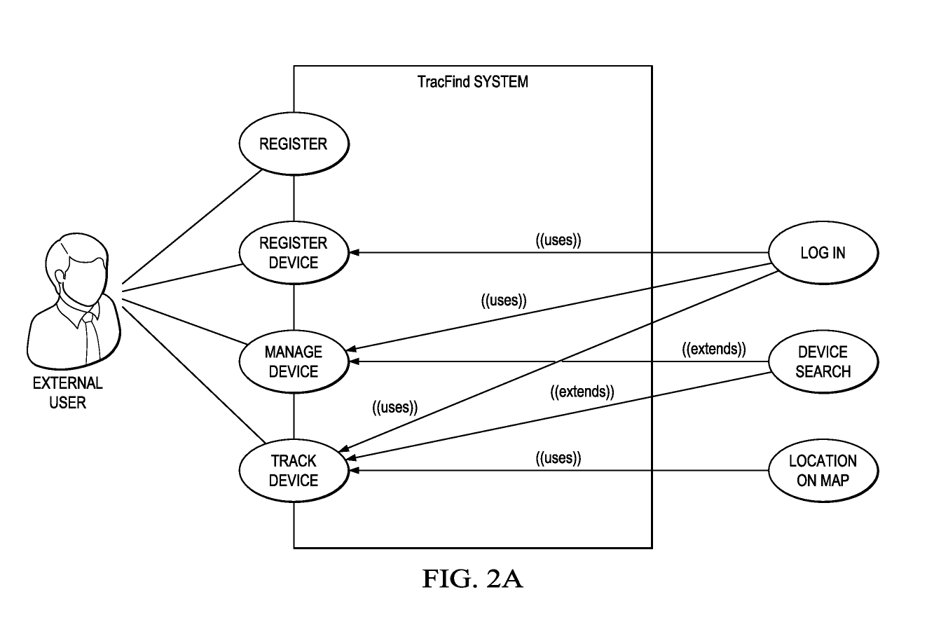

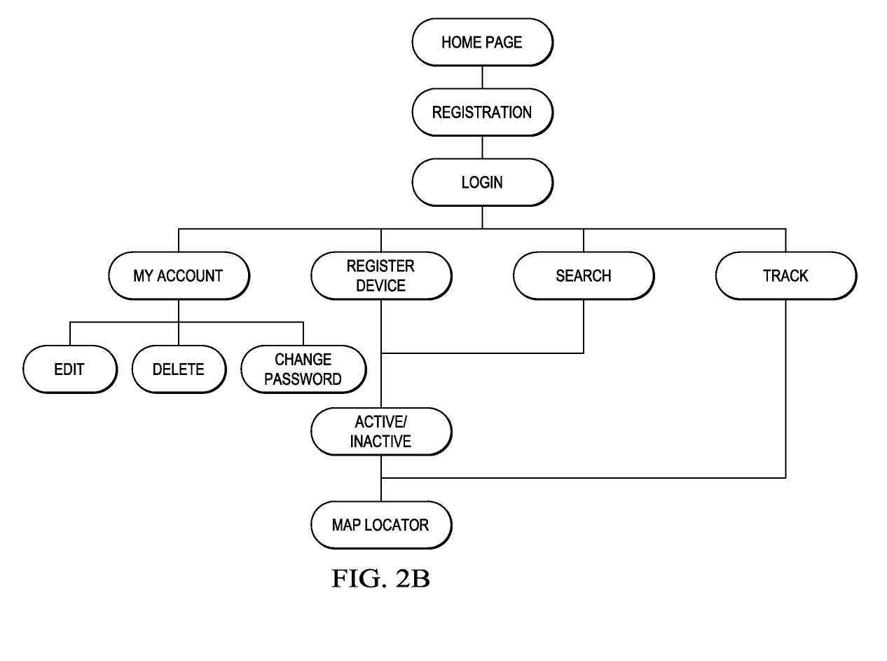

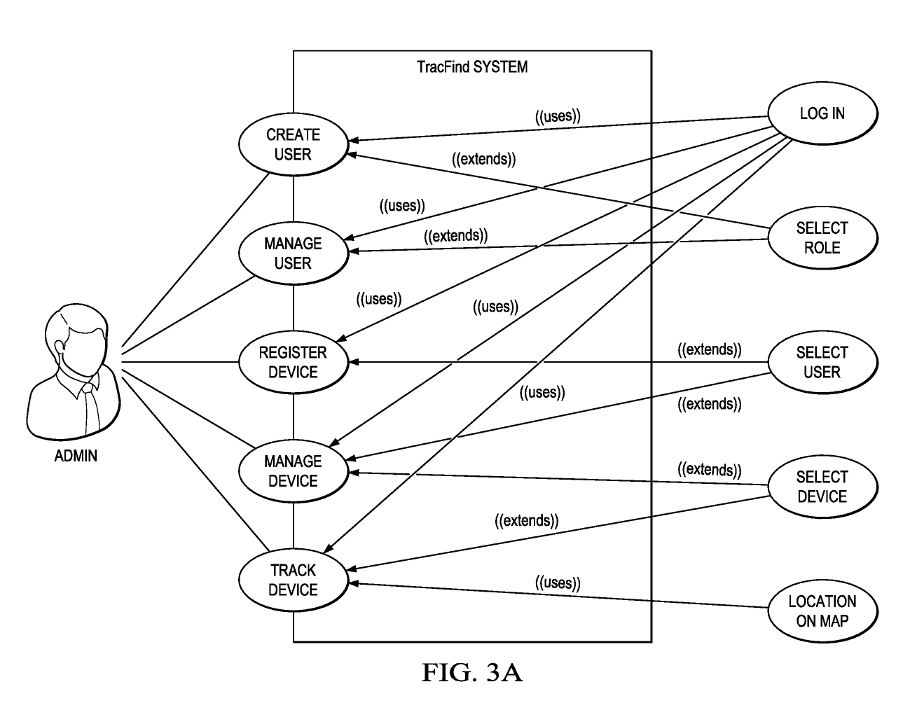

FIG. 2A depicts an interface layer between an external user and an application according to an embodiment of the invention;

FIG. 2B is a step-by-step flowchart of user interactions according to an embodiment of the invention;

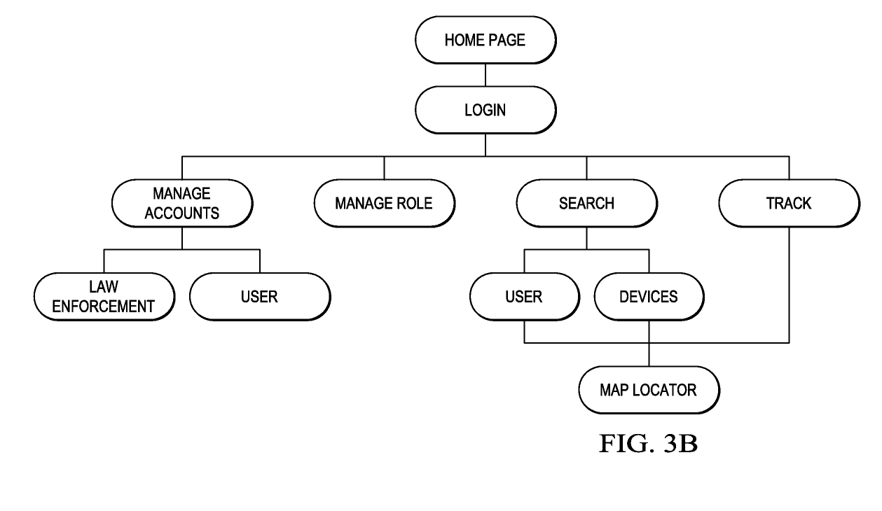

FIG. 3A depicts an interface layer between an administrator and an application according to an embodiment of the invention;

FIG. 3B is a step-by-step flow chart of administrator interactions according to an embodiment of the invention;

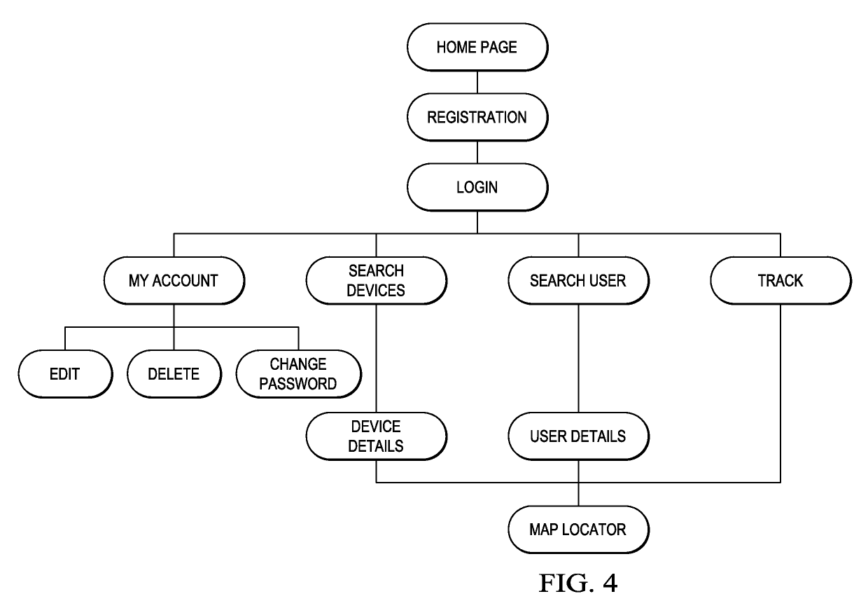

FIG. 4 is a step-by-step flow chart of interactions of an authorized third party, according to an embodiment of the invention;

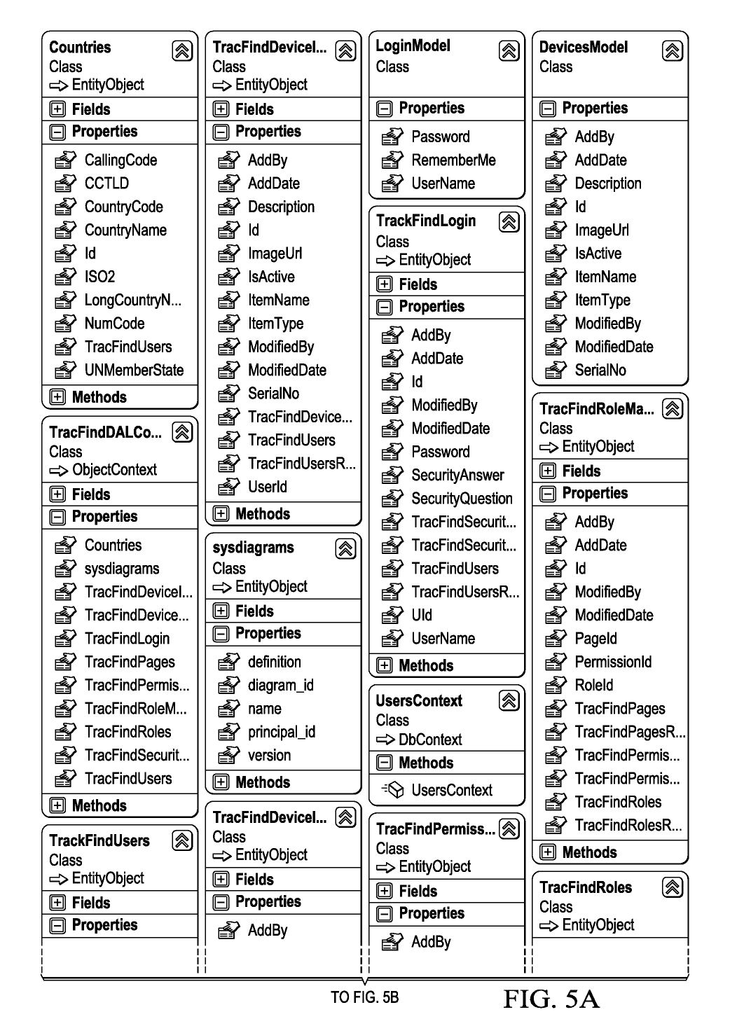

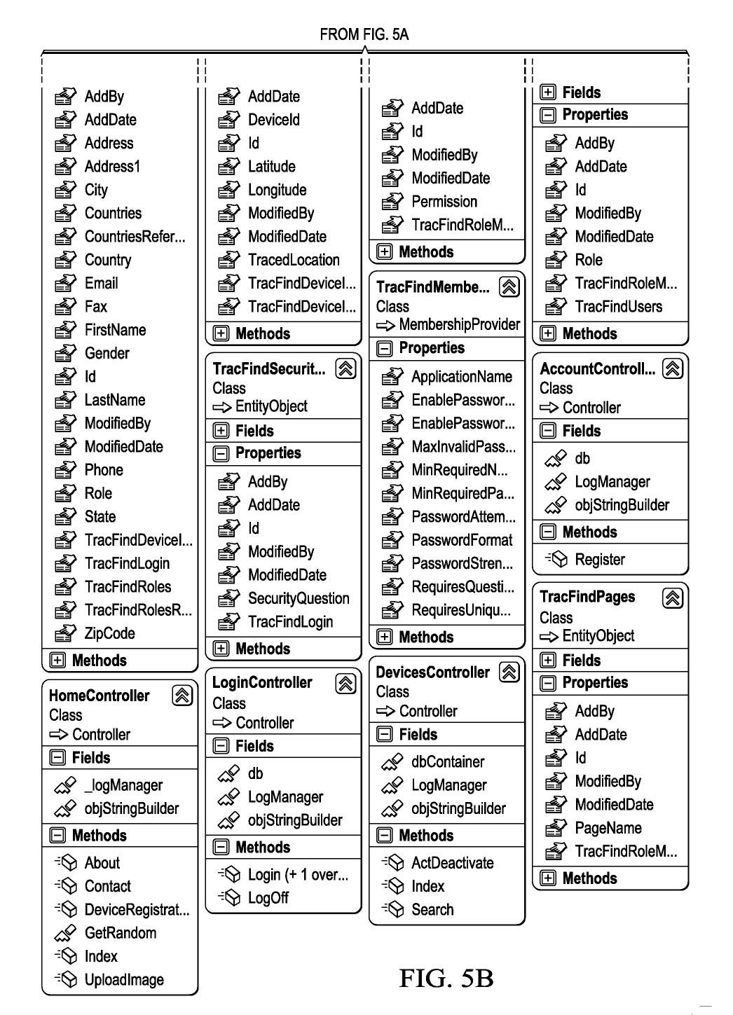

FIGS. 5A and 5B is a class diagram of a software application according to an embodiment of the invention;

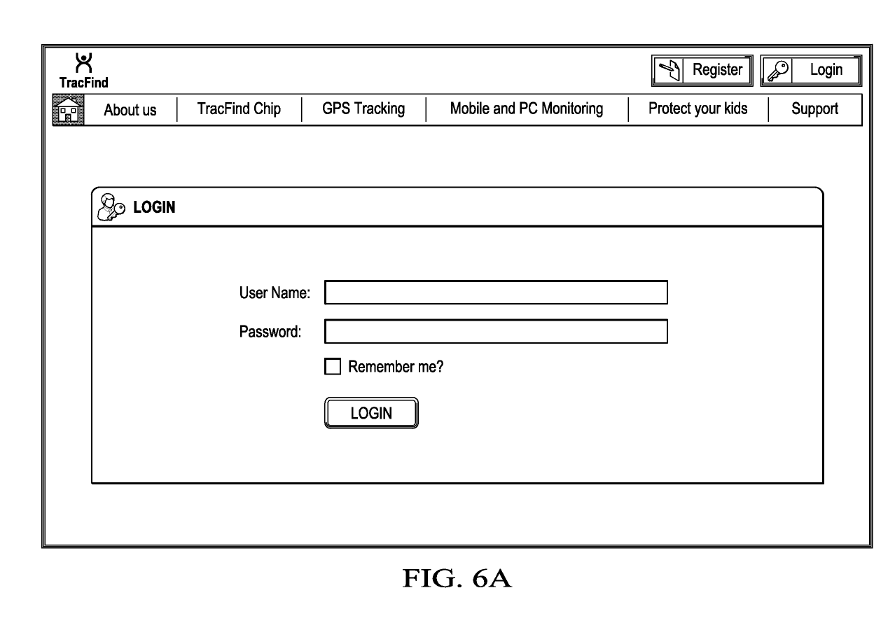

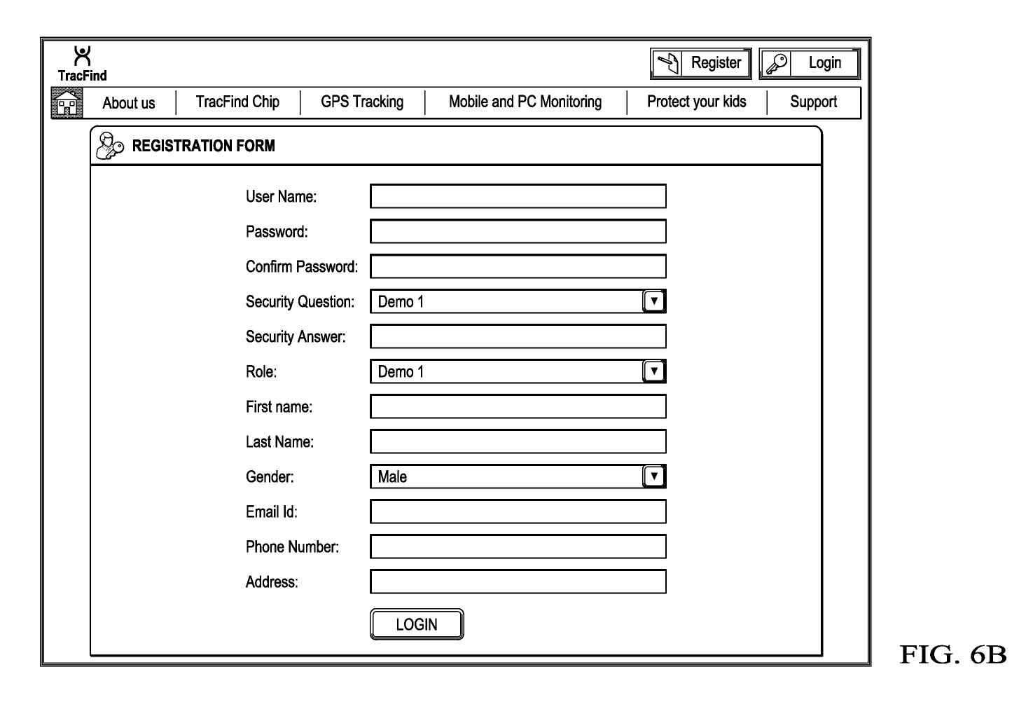

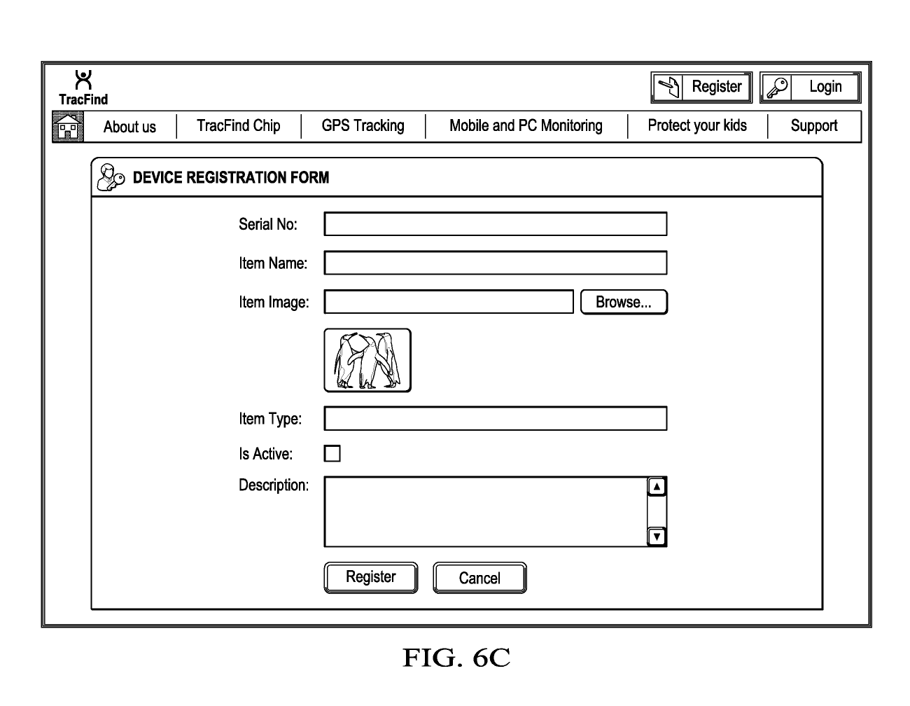

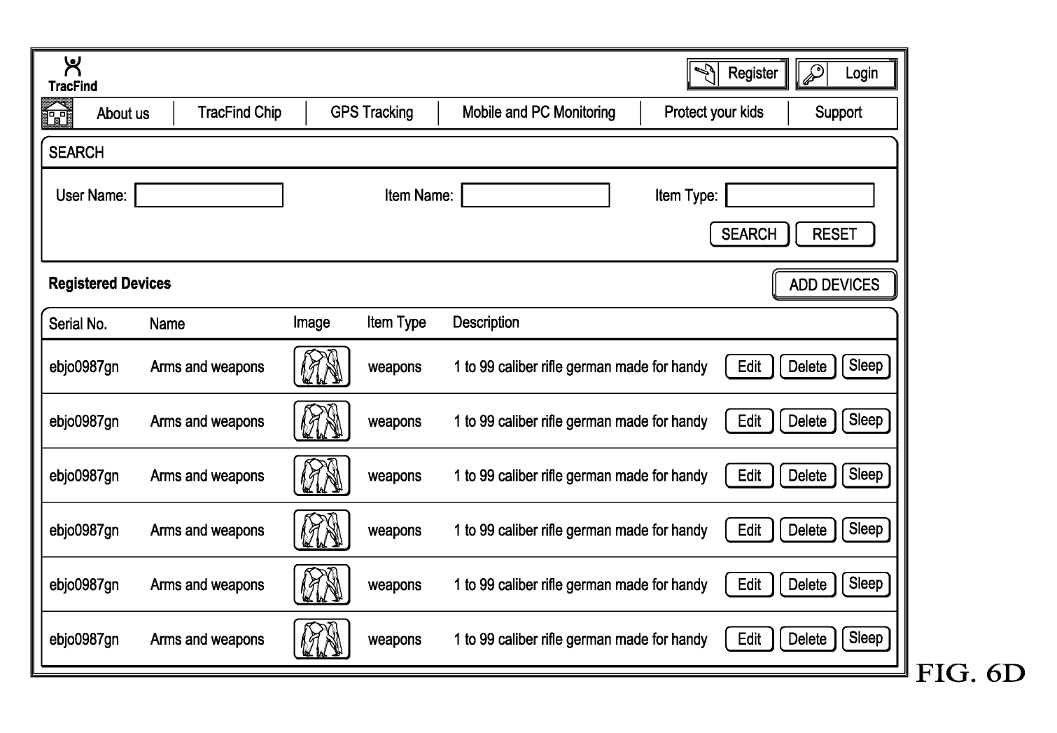

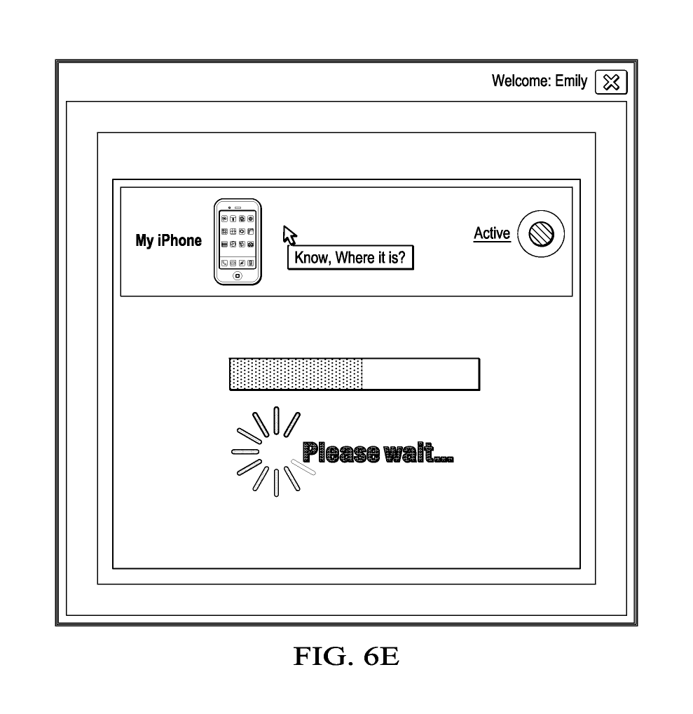

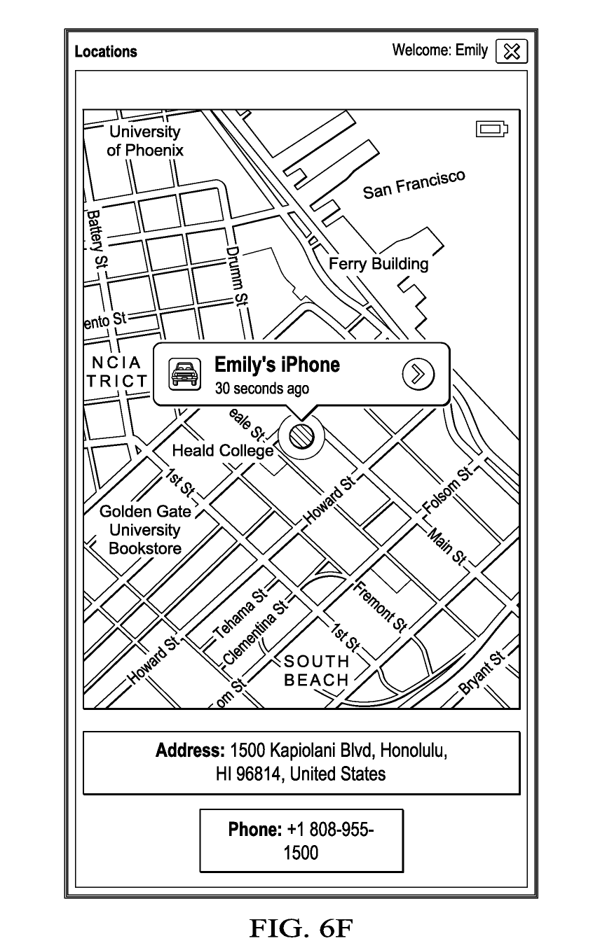

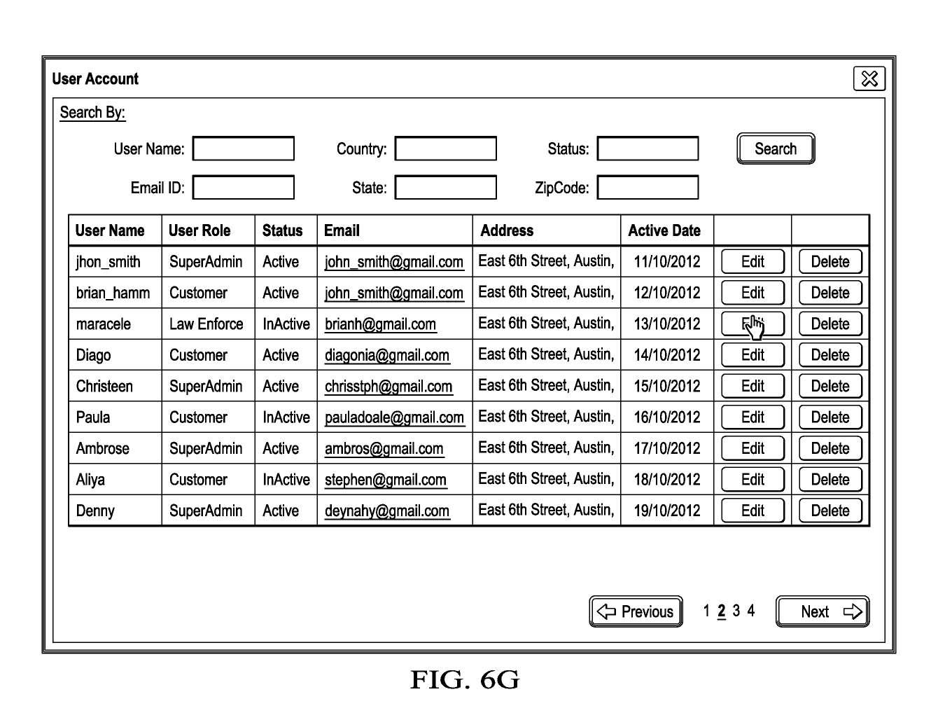

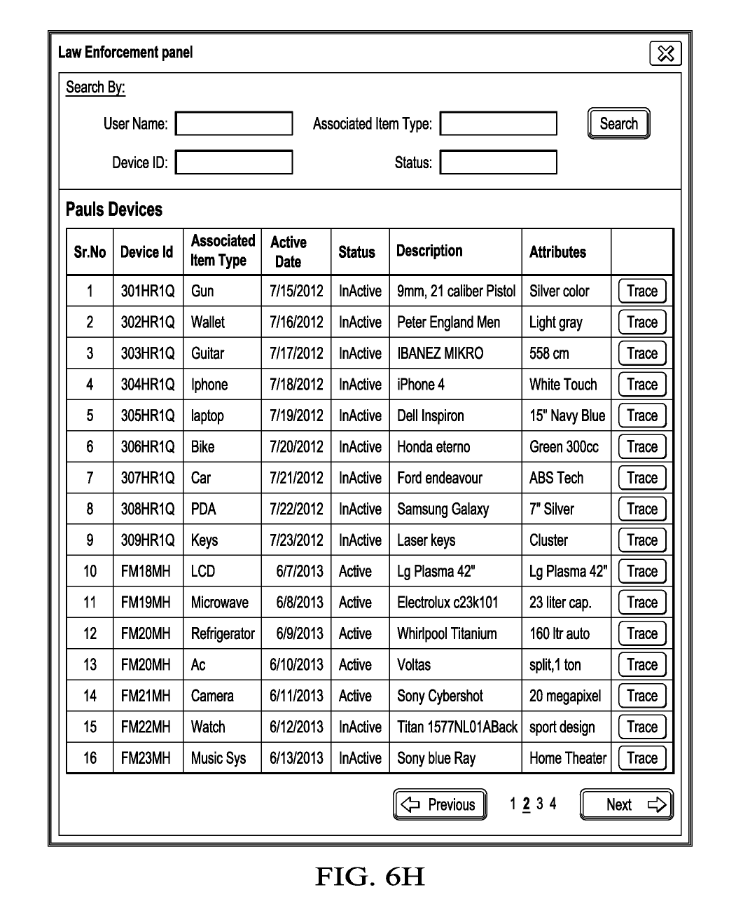

FIG. 6A is a screenshot of an exemplary login page according to an embodiment of the invention;

FIG. 6B is a screenshot of an exemplary user registration page according to an embodiment of the invention;

FIG. 6C is a screenshot of an exemplary device registration page according to an embodiment of the invention;

FIG. 6D is a screenshot of an exemplary device listing page according to an embodiment of the invention;

FIG. 6E is a screenshot of an exemplary processing request and completion status page according to an embodiment of the invention;

FIG. 6F is a screenshot of an exemplary device locator page according to an embodiment of the invention;

FIG. 6G is a screenshot of an exemplary user list page according to an embodiment of the invention;

FIG. 6H is a screenshot of an exemplary device listing page of a user, as accessed by an authorized third party, according to an embodiment of the invention;

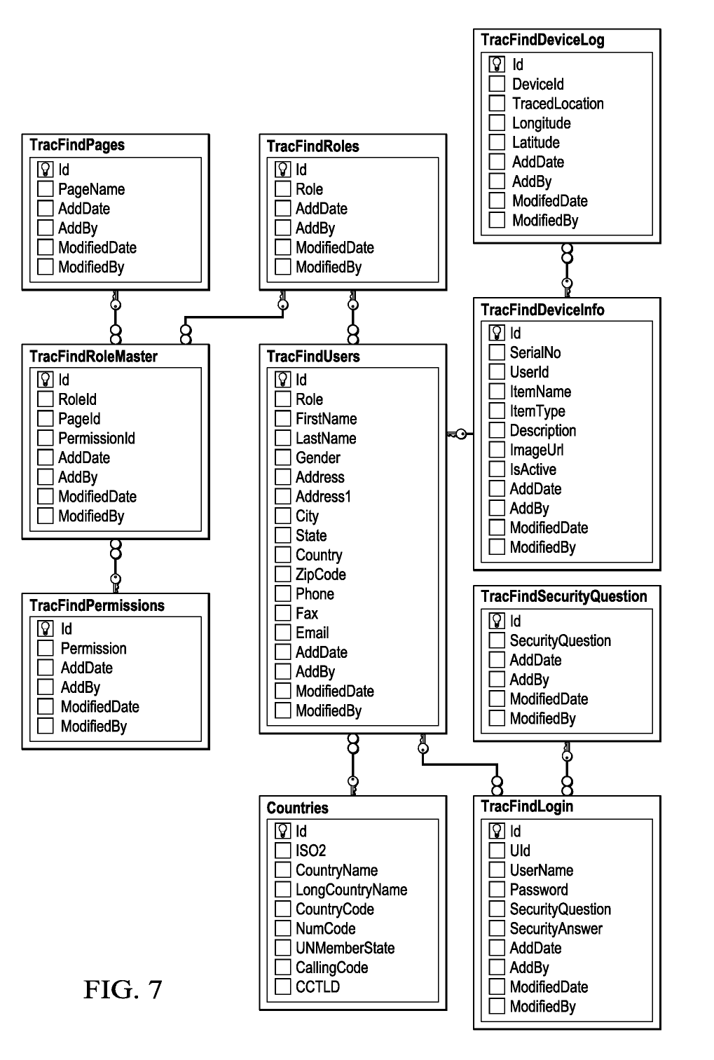

FIG. 7 is an entity-relationship of a database according to an embodiment of the invention;

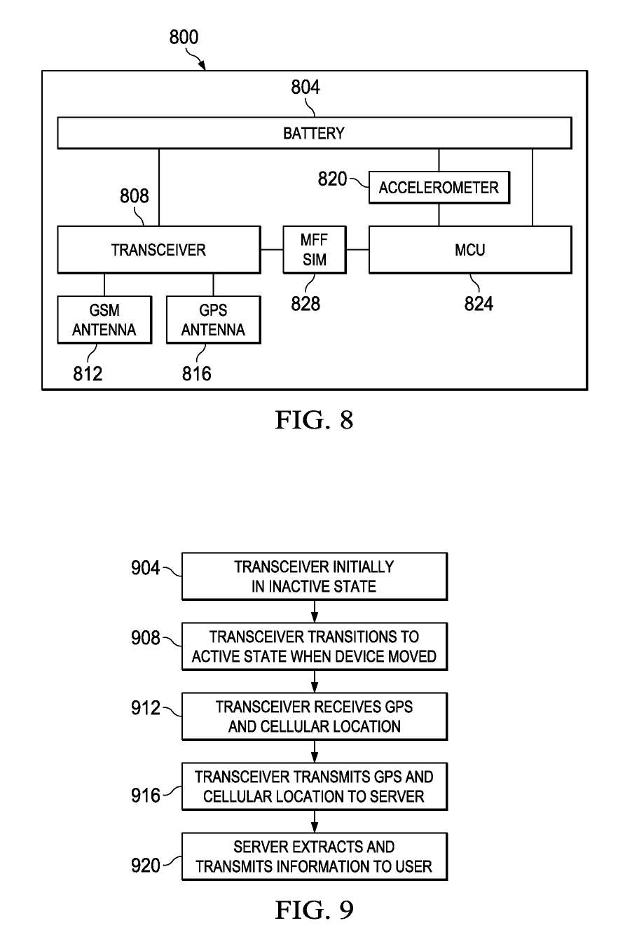

FIG. 8 is a system-level block diagram of a device according to an embodiment of the invention; and

FIG. 9 is a flow diagram of a method according to an embodiment of the invention.

### DETAILED DESCRIPTION

In the following detailed description, reference is made to the accompanying drawings, which form a part thereof, and within which are shown by way of illustration specific embodiments by which the invention may be practiced. It is to be understood that other embodiments may be used, and structural changes may be made, without departing from the scope of the invention.

Introduced herein is a GPS-tracked device designed to track physical assets and people. The GPS-tracked device remains in an inactive state unless moved from its location. When moved from its location, the device transitions from the inactive state to an active state wherein the device communicates. The device consumes significantly less power in the inactive state than in the active state. Since the device mostly remains in the inactive state unless moved from its location, the device utilizes battery power more efficiently, thereby increasing its operating time. Also introduced herein are a software application and associated non-transitory, tangible medium configured to run the GPS-tracked device.

In another embodiment, a GPS-tracked microchip or tag can be applied to any fixed or moving object for location tracing. Examples include, but are not limited to, guns, children's backpacks, wallets, cellular phones, computers, televisions, persons, tablets, motorcycles, bicycles, boats, pet collars, senior citizens, remote control for television, clothing, jewelry, cameras, sporting equipment, etc. The GPS-tracked tag is assigned a serial number that is registered by the user on an associated database. At this point, the tag and underlying object is immediately activated on a computer-based application that can be run on any computer-based device (e.g., smart phone, computer, tablet). Upon activation, the object with GPS-tracked tag is deemed “secured”. The application allows the user to instantly track and find the secured object at any time and in any location. The tag is linked to the application, which is linked to a GPS system that can trace, track, and find the secured object to which the tag is attached or otherwise associated.

Characteristics of the embodiments described herein include, but are not limited to, portability, compliance with state and federal laws regarding surveillance and telecommunications, water- and weatherproof, wide temperature range of operability, leveraging of geo-fencing software, and inability to be detected.

When the software capabilities and GPS-tracked tags are integrated, the application is linked to both a GPS system and the tag. Thus, a user would attach the tag to any movable or stationary item, such as a person (e.g., article of clothing, inside a watch band, key ring, etc.) or tangible object of any kind (e.g., gun, bicycle, bicycle helmet, wallet, purse, etc.), and the user would enter the serial number assigned to the tag into the application to activate the serial number and associated tag. In an embodiment, the application would further be linked to a web-based application or database accessible by law enforcement personnel and/or any other third party with whom a customer elects to share its data. The database would include the serial numbers of all active GPS-tracked tags. In another embodiment, the tags are logged into a national database of law enforcement agencies such that some of the agencies in the database are provided with a direct link to track the tags immediately after the tags have been moved past a defined perimeter. In a related embodiment, the tags are further logged into a national database for access by one or more third parties with whom a customer elects to share its data.

Thus, for example, if an individual goes missing but has a tag present on their person, then not only can a user access the location of the individual, but law enforcement personnel (and perhaps any other third party with whom a customer elects to share its data) would also be able to access the location immediately, as the first few hours upon disappearance of an individual is the most critical.

As another example, if a personal possession is stolen but has an attached tag, then the user can locate that personal possession immediately by tracking that possession via the database containing the serial number.

As another example, if a student leaves his/her backpack, computer, and/or cellular phone but the article has an attached tag, then the student can input the serial number or associated identification code into the application, and the student can view all tags that the student has registered. A GPS system can then show the student where each article is located.

As another example, if a gun is stolen (the tag can be placed inside the handle or stock of the gun), the gun can be immediately traced by the gun owner, by law enforcement or any other third party with whom a customer elects to share its data, tracking the gun through one or more databases. Not only would this speed up time to recover the gun, but crime could be prevented by locating the gun sooner.

Advantages or objectives of certain embodiments of the invention include (1) an ability to create a web-based account and manage one or more secured items; (2) an ability to register, with a national database of law enforcement agencies and/or any other third party with whom a customer elects to share its data, a secured item based on a serial number associated with the attached GPS-tracked tag; (3) an ability to apply statuses to users, such as administrators, customers, law enforcement, etc.; (4) an ability for a law enforcement personnel or other authorized third-party personnel to access a user and/or track location of the secured item of the user immediately after the secured item has been moved past a defined perimeter; (5) an ability to track a secured device on a GPS-based chip or tag secured to the device; (6) a capability of the GPS-tracked tag to have an adjustable or adaptable active status and sleep mode to extend battery life and to customize user experience; (7) an ability of a system to generate and send a wireless signal to the GPS-tracked tag and receive a results packet (latitude/longitude/location) from the GPS-tracked tag for description depiction of location of the tag on a computer-generated map; (8) an ability to automatically record tracked information saved to a database or the tracked device itself for future use or consultation; (9) an ability for any user to track or look up location of any device or article to which a GPS tag is secured; and (10) universal applicability of a GPS tag on any fixed or moving device or article, such that a stolen device can be tracked and recovered.

### EXAMPLES

As seen in FIG. 1, the architecture 100 selected for the computer-based application may be a model-view-controller pattern, though any suitable pattern is envisioned. The application 110 is in communication with the user 120 via user authentication, with the database 130 via an authorized third party, and with the GPS-tracked tag 140 via the server/reader 150. In operation, upon attaching the tag 140 to a person or device, the user 120 activates the serial number associated with the tag 140 on the application 110 by filling in information about the tag 140 and device to register the tag's serial number, along with information about the user 120. This device and user information is stored on the application 110.

When the user 120 wishes to access the GPS-tracked tags and associated devices, the user 120 inputs user information for authentication. A listing of each registered device is outputted to the user 120. The user 120 can immediately send an activating or deactivating signal to any of the registered tags. The user 120 would input the appropriate command on the application 110, and the application 110 would send a request to server 150 (optionally via an authorized third party). The activating or deactivating signal is transmitted to the antenna 160, which subsequently transmits the signal to the tag 140.

The tag 140 receives the signal, and in return, the tag automatically sends a data packet, containing the latitude, longitude, and other location information of the device, to the antenna 160, which, in turn, transmits the data packet to the server 150. The server 150 extracts the data packet information and transmits the extracted information to the database 130 (optionally via an authorized third party). Simultaneously, the data packet information is converted into an appropriate language-based response that is transmitted to the application 110. The response is displayed to the user 120 over the application 110 in the form of a map or other indication of the location of the tag.

Further, the extracted data packet information stored in the database 130 may be retrieved by authorized parties, such as law enforcement personnel or those of any other third party with whom a customer elects to share its data. In this case, the authorized party can also transmit a request to the server for the location of the GPS-tracked tag. Thus, the authorized party can also retrieve location information in real-time.

FIG. 2A depicts an interface layer 200 between an external user 210 (as opposed to an internal user, such as an administrator or authorized party, e.g., law enforcement) and the computer-based application 220. Once the external user 210 is registered (i.e., user information inputted and stored), the user 210 can register a device (with attached GPS-tracked tag), manage a device, and track a device by logging into the application. By searching for a device, the user can manage and track the device. By requesting location of the device, the user can track the device.

TABLE 1
External User's Interaction With the Application
According to an Embodiment of the Invention

| | |
|---|---|
| Use Case | External user interaction |
| Actors | External User |
| Operations | DoLogin( ), Register |
| Description | 1. External user can register user |
| | information and create account |
| | in the application |
| | 2. Already registered user can |
| | login and add device and manage |
| | already registered devices. |
| | 3. User can search device by device |
| | ID and/or item on which device |
| | is attached. |
| | 4. User can track particular device |
| | and location will show on |
| | computer-based map. |

FIG. 2B is a flowchart 250 showing the step-by-step process of a user's interaction with the application according to an embodiment of the invention. Once registered, a user logs into the application, where the user can visit the user profile and edit or delete the account or change password for authentication. The user can also register a device with tag, activate/inactivate the tag, and locate the tag on a map. The user can also search for a device with tag, activate/inactivate the tag, and locate the tag on a map. The user can also track a device with tag and locate the tag on a map.

FIG. 3A depicts an interface layer 300 between an administrator 310 and the computer-based application 320. By logging into the application 320, the administrator 310 can create a user, manage a user, register a device (with attached GPS-tracked tag), manage a device, or track a device. An administrator can also select roles of the user, for example as an external user or administrator, by creating the user or managing the user. By selecting a user, the administrator can register a device or manage a device. By selecting a device, the administrator can manage the device or track the device. By requesting location of the device, the administrator can track the device.

TABLE 2
Administrator's Interaction With the Application
According to an Embodiment of the Invention

| | |
|---|---|
| Use Case | Administrator interaction |
| Actors | Admin |
| Operations | DoLogin( ) |
| Description | 1. Admin will login and can create |
| | user with specific role. |
| | 2. Admin can also manage |
| | information of any existing |
| | user. |
| | 3. Admin can register new device |
| | under any user or manage any |
| | device information. |
| | 4. Admin can search any device by |
| | device ID, user, and item on |
| | which device is attached. |
| | 5. Admin can track device and |
| | location will show on computer- |
| | based map. |

FIG. 3B is a flowchart 350 showing the step-by-step process of an administrator's interaction with the application according to an embodiment of the invention. Once the administrator 310 logs into the application, the administrator 310 can manage the account of any external user or authorized third party (e.g., law enforcement). The administrator 310 can also manage the roles of any user 210 or of the administrator 310. The administrator can also search for a user or device with tag, either of which can lead to the location of the tag on a map. The administrator 310 can also track a device with tag and locate the tag on a map.

FIG. 4 is a flowchart 400 showing the step-by-step process of the interaction between an authorized third party 410 (TP) (e.g., law enforcement personnel) and the application according to an embodiment of the invention. Once registered, a TP logs into the application, where the TP can visit the TP profile and edit or delete the account or change password for authentication. The TP can also search for a device with tags, obtain details about the device, and locate the tag on a map. The TP can also search for a registered user, obtain details about the user, and locate one of the user's tags on a map. The TP can also track a device with tag and locate the tag on a map.

FIGS. 5A and 5B depict exemplary class diagrams 500 and 550 of software run on a non-transitory, tangible medium, according to an embodiment of the invention. The class diagrams 500 and 550 show the system's breakdown of types, instances, attributes, and operations or methods according to this embodiment of the invention. For example, the class diagrams 500 and 550 depict the possible roles of users, user information stored in the application, tag information, device information, login controllers, device controllers, among other aspects of the software application.

FIGS. 6A-6E are exemplary screenshots of the application according to an embodiment of the invention. FIG. 6A is a login page 610, which allows different users to be authenticated and granted access for interaction with the application according to their assigned role.

FIG. 6B is a user registration page 620 for a user to input user-related information, such as name, address, role, gender, etc.

FIG. 6C is a device registration page 630 for registering a device with tag. Information needed for input may include device identification, associated item type, serial number, etc., along with selection of the inactive or active mode of the tag. Special rules may also apply, for example automatically activating a tag at certain times of the day.

FIG. 6D shows a list of registered devices 640 as registered by a user. The list also shows the associated device type (e.g., phone, wallet, guitar, laptop computer, etc.). The user can search for the device or tag by device identification, name of associated device type, status of tag/device as active or inactive, etc. From this page, the user can also activate or deactivate a tag. Once the user begins tracking the device, the application interacts with the WCF service library that is used for communication with the tag and saving tag/device information into the database.

FIG. 6E is a holdover page 650 for when the application is sending signals to and receiving signals from the tag through the server. This page may have a status indicator bar of information transmission until completion. This screen may appear when the user processes a request of the tag/device.

FIG. 6F is a device locator page 660 that shows the location of the device search. This page may include any location information, for example latitude and longitude, address, phone number, etc.

FIG. 6G shows a listing of users 670 as may appear for an administrator. Appropriate information is displayed, for example name, role, status, email address, mailing address, activation date, etc. From this page, an administrator or authorized third party (e.g., parents overlooking their children's accounts) may edit or delete the account and may search users through any criteria, such as name, email address, country, state, status, zip code, etc. Various paging functionalities for navigating through different pages of the list is contemplated.

FIG. 6H is a page 680 that may appear to an authorized third party, such as law enforcement or third-party personnel. This particular page shows a listing of tags and associated devices belonging to a single user. The authorized third party can perform searches of a user or device by searching user name, device identification, status, device name, etc. The authorized third party can then trace the device with tag to ensure proper location.

FIG. 7 is an entity-relationship diagram 700 depicting an exemplary database used in an embodiment of the invention. The database may include any suitable entities, for example including, but not limited to, tag/device logs, tag/device information, user information, permissions, user roles, login information, etc.

Any suitable tags and chipsets may be utilized with the invention. For example, the tag may be the SKORPA TELEMETRY SnapTrax Logger, SKORPA TELEMETRY Communicator GPS MicroTraX Tags, SKORPA TELEMETRY Voyager GPS MicroTraX Tags, SKORPA TELEMETRY Pathfinder GPS MicroTraX Tags, and SKORPA TELEMETRY SnapTraX Solar, which are all incorporated herein by reference. The chipsets may be manufactured by RAKON, IRIDIUM LIMITED, DIAMOND POINT INTERNATIONAL, ROCKWELL COLLINS, RF SOLUTIONS LTD., and SEMICONDUCTOR STORE, all of which have chipsets that are incorporated herein by reference. However, as is indicated, a variety of tags, microchips, and chipsets may be suitable for incorporation of various embodiments of the invention.

FIG. 8 is a system-level block diagram of a GPS-tracked device 800 according to disclosed embodiments. The device 800 can be implemented as a microchip or a tag attachable to any suitable item such as, for example, a backpack, a watch, a handgun, a laptop computer or to any person or animal.

Referring to FIG. 8, the device 800 includes a battery 804 connected to various other components of the device 800. The battery 804 provides electrical power to the other components of the device 800. The battery 804 may, for example, be a Lithium Ion-type battery.

The device 800 includes a transceiver circuit 808 connected to the battery 804. The transceiver circuit 808 is connected to a cellular antenna 812 and also to a global positioning satellite (GPS) antenna 816. The cellular antenna 812 enables the transceiver circuit 808 to wirelessly communicate with a cellular network. The cellular antenna 812 may, for example, be a GSM antenna or a CDMA antenna. The GPS antenna 816 enables the transceiver circuit 808 to wirelessly communicate with a satellite.

The device 800 includes an accelerometer 820 connected to the battery 804. The accelerometer 820 is configured to detect any movement of the device. Upon detection that the device 800 has moved from its location, the accelerometer 820 generates a first signal which is applied to a MCU 824.

According to disclosed embodiments, a user or an authorized third party such as an administrator may set a perimeter around the device 800. When such a perimeter is set, only the movement that takes place outside this perimeter causes a generation of the first signal. In one embodiment, a user or an authorized party such as an administrator may set a perimeter around another ‘secured’ device. In this particular embodiment, only when the device 800 is a certain distance away from that another ‘secured’ device, the accelerometer 820 generates a first signal and the movement of the device 800 is tracked thereafter.

In response to the generation of the first signal, the MCU 824 generates a second signal which is applied to a MFF SIM 828. Responsive to the second signal, the MFF SIM 828 generates a third signal which is applied to the transceiver circuit 808. In other embodiments, the first signal from the accelerometer 812 is directly applied to the transceiver circuit 808, thereby eliminating the MCU 824 and the MFF SIM 828. According to disclosed embodiments, the transceiver circuit 808 initially remains in an inactive or “sleep” state. Upon receiving the third signal (or the first signal), the transceiver circuit 808 transitions from the inactive state to an active state. In the active state, the transceiver circuit 808 receives a data packet containing its own cellular location data from the cellular network. The transceiver circuit 808 also receives GPS location data from a GPS satellite via the GPS antenna 816.

According to disclosed embodiments, the transceiver circuit 808 transmits a data packet containing the cellular location and the GPS location to a server/reader. The server/reader has been described before and is also shown in FIG. 1. The server/reader stores a computer-based application which is in communication with a user via user authentication. The application is also in communication with the database shown in FIG. 1 via an authorized third party, and with the device 800 via the server/reader.

According to disclosed embodiments, the application stored in the server may be implemented as a service for locating the device 800. The operation of the application has been described before. Upon reception of the data packet containing the location information from the device 800, the application may notify a user that the device 800 has moved from its location, and in embodiments where the perimeter has been set, the application may notify the user that the device 800 has moved outside of the perimeter. The application may notify the user via a short messaging service (SMS) and also provide the current location of the device 800. In one embodiment, the application may notify a person or an entity other than the user that the device 800 has moved. This feature may be activated for a predefined time period, e.g., during the time the user is away for a vacation such that someone who is close by the device 800 can look after the device 800.

Also, the application may transmit the current location of the device 800 to the database with a date and a time stamp so that data regarding movement of the device 800 is maintained in the database. In one embodiment, the data regarding movement of the device 800 is also stored within the device 800 itself. When the user wishes to access the device 800, the user can access the application by inputting user information for authentication. The user can send an activating or deactivating signal to the device 800. The device 800 receives the signal, and in return sends a data packet containing the latitude, longitude, and other location information of the device 800 to the server. The server extracts the data packet information and transmits the extracted information to the user and/or to an authorized third party.

According to disclosed embodiments, the device 800 is logged into a national database of law enforcement agencies and/or a database associated with any other third party with whom a customer elects to share its data. In this embodiment, when the device 800 is on the move or outside of a predefined perimeter, a pre-selected group of law enforcement agencies or third-party agents that are in the database is automatically notified and immediately (e.g., before the user's report) provided a direct link for tracking the movement of the device 800. The notified group of law enforcement agencies includes law enforcement agencies in a particular area, e.g., some or all law enforcement agencies in a particular zip code, or law enforcement agencies that are in a closed vicinity of the device's last location. In one embodiment, the national database includes private security monitoring companies.

The extracted information can be displayed to the user over the application in the form of a map or other indication of the location of the device 800. Also, the extracted data packet information stored in the database may be retrieved by authorized third parties, such as law enforcement personnel.

When the transceiver circuit 808 remains in the inactive state, the rate of power consumption of the transceiver circuit 808 is less than when the transceiver circuit 808 transmits or receives signals. Since the transceiver circuit 808 mostly remains in a sleep mode and only communicates when the device 800 is moved from its location, the transceiver circuit operates at a reduced rate of power consumption, thus increasing its operational time.

In certain embodiments, a user takes a photo of the item that the device 800 is placed in or on and that photo is assigned to the specific item the device 800 is placed in or on, and that specific photo is associated with the user's account. Once the item is on the move, the user has a display of that specific item with the photo of the item on or in which the user has placed the device 800. If the user elected to share his data with law enforcement or any third party, the photo of the item on the move appears. For example, a user places devices 800 on or in five different objects, people or things (e.g., a gun, motorcycle, bicycle, flat screen television, child backpack). The user receives, e.g., a SMS message ALERT on his mobile device to log on to a web site to track his device. Once the user is logged into his account the specific item, represented by the associated photograph, may appear on a map, showing that it is on the move. If the user shared his data with law enforcement, law enforcement can likewise view the photo overlain on the map. In one embodiment, using the application, a photo and/or other data for identifying the device with a message may be sent to anyone such as a temporary caretaker or a law enforcement agency by an email or a text message.

FIG. 9 is a flow diagram of a method according to disclosed embodiments. In block 904, the transceiver circuit 808 initially remains in an inactive or sleep state. The transceiver circuit 808 may enter the inactive state upon receiving a command from a user.

In block 908, the device is moved from its location, which causes the transceiver circuit 808 to transition from the inactive state to an active state and establish communication with a cellular network and a GPS satellite. In block 912, the transceiver circuit 808 receives a data packet containing its cellular location information from the cellular network and receives a data packet containing its GPS location information from the GPS satellite.

In block 916, the transceiver circuit 808 transmits a data packet containing its cellular location and its GPS location to a server. In block 920, the server extracts the data packet information and transmits the extracted information to a user and/or to an authorized third party. The extracted information can be displayed to the user over the application in the form of a map or other indication of the location of the device 800. Also, the extracted data packet information stored in a database may be retrieved by authorized third parties, such as law enforcement personnel.

FIG. 10 is a flow diagram of a method 1000 according to disclosed embodiment. The method 1000 is a method of preventing a loss of an asset. As discussed before, an asset may be any valuable/inherently dangerous items such as jewelry, electronics, and a firearm, or wearable/portable items such as a backpack, a collar, a watch, and a portable electronics.

The method 1000 starts at a start step at 1000. In step 1004, a device such as the device 800 in FIG. 8 is provided. The device is logged into a national database of law enforcement agencies. In one embodiment, the database includes, in addition to government agencies, some private security monitoring companies. In step 1006, a movement of the device outside of a predefined perimeter is detected. The perimeter is set, prior to step 1004, around the device itself or around another ‘secured’ device.

In step 1006, upon detecting the movement of the device outside of the predefined perimeter, some of the law enforcement agencies in the national database are immediately notified and provided a direct link for tracing the device. As such, when the device is on the move, some of the agencies in the database are notified even before a report by a user and given a direct link to track the device right away. In one embodiment, all law enforcement agencies in a particular zip code are immediately notified for a possible theft/loss. In other embodiment, law enforcement agencies in a close vicinity of the device are immediately notified.

In step 1010, the method 1000 notifies the user of the device that the device has moved outside of the predefined perimeter. The user may be notified via either a SMS message or an email. In one embodiment, for a predefined time period set by the user, someone other than the user may be notified of a possible theft/loss. As discussed above, this may be useful when the user is away on a vacation and someone who lives close by the device is looking out for the device.

Data associated with the movement of the device may be useful in prosecuting or investigating the theft/loss. In one embodiment, in addition to a remote database, such data is also stored within the device itself such that the data may be recovered from the device if the data in the database becomes unavailable.

Application

The non-transitory, tangible, computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the embodiments described herein may be written in any combination of one or more programming languages, including an object oriented programming language such as Java, J-query, .NET, SQL, C#, C++ or the like and conventional procedural programming languages, such as the “C” programming language or similar programming languages.

Certain embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A method of preventing a loss of an asset, comprising:
providing a device that is logged into a national database of law enforcement agencies;
detecting a movement of the device outside of a predefined perimeter; and
upon said detecting, immediately providing a direct link for tracking said movement of the device to at least one law enforcement agency of said national database.

2. The method of claim 1, wherein said device is attached to said asset.

3. The method of claim 1, the method further comprising notifying a user associated with said device that said device has moved outside of said predefined perimeter.

4. The method of claim 3, wherein said notifying includes sending a short messaging service (SMS) message to said user.

5. The method of claim 1, wherein said perimeter is set around another tracked device.

6. The method of claim 1, wherein said at least one law enforcement agency includes all law enforcement agencies within a particular zip code.

7. The method of claim 1, wherein said national database includes a private security monitoring company.

8. The method of claim 3, wherein said notifying includes, for a predefined time period, notifying someone other than said user that said device has moved outside of said predefined area.

9. The method of claim 1, further comprising storing within said device data associated said movement of said device.

10. A system for preventing a loss of an asset, comprising:
a server; and
a device logged into a national database of law enforcement agencies, said device comprising:
an accelerometer configured to detect a movement of said device outside of a predefined perimeter,
a transceiver circuit configured to cause, upon said detection by said accelerometer, said server to immediately provide at least one law enforcement agency of said law enforcement agencies a direct link for tracking said movement of said device, and
a battery coupled to said accelerometer and to said transceiver circuit.

11. The system of claim 10, wherein said device is attached to said asset.

12. The system of claim 10, wherein said device is further configured to cause said server to notify a user associated with said device that said device has moved outside of said predefined perimeter.

13. The system of claim 12, wherein said notification includes sending a short messaging service (SMS) message to said user.

14. The system of claim 10, wherein said perimeter is set around another tracked device.

15. The system of claim 10, wherein said at least one law enforcement agency includes all law enforcement agencies within a particular zip code.

16. The system of claim 10, wherein said national database includes a private security monitoring company.

17. The system of claim 12, wherein for a predefined time period, said notification is sent to someone other than said user that said device has moved outside of said predefined area.

18. The system of claim 10, wherein data associated said movement of said device is stored within said device.

19. The system of claim 10, wherein said server is configured to send identifying data of said device to a party via an email or a text message.
